(19) United States
(12) Patent Application Publication
(10) Pub. No.: US 2022/0327606 A1
(43) Pub. Date: Oct. 13, 2022

(54) SYSTEM AND METHOD FOR RENDERING CONTEXTUAL CATALOGUE OF PRODUCTS FOR ELECTRONIC COMMERCE PLATFORM

(71) Applicant: 1ClickPay Inc, Sammamish, WA (US)

(72) Inventor: Kumar N. Senthil, Sammamish, WA (US)

(73) Assignee: 1ClickPay Inc

(21) Appl. No.: 17/227,693

(22) Filed: Apr. 12, 2021

(51) Int. Cl. G06Q 30/06; G06F 16/951; G06Q 30/02

(52) U.S. Cl. CPC G06Q 30/0641; G06Q 30/0603; G06F 16/951; G06Q 30/0627; G06Q 30/0201

(57) ABSTRACT

A system for rendering contextual catalogue of products is disclosed. A master catalogue generation module receives one or more product details corresponding to the one or more products from a plurality of merchants, generates a master catalogue. A contextual catalogue rendering module determines a context of each of one or more web-based platforms exhibiting the master catalogue, determines a category of each the one or more web-based platforms, matches the category of each of the one or more web-based platforms with the corresponding plurality of merchants, renders one or more contextual catalogues corresponding to the master catalogue. A catalogue modification module enables the plurality of merchants and one or more owners associated with the one or more web-based platforms to override the one or more contextual catalogues rendered. A product purchasing facilitation module facilitates purchasing of the one or more products selected from the one or more contextual catalogues.

### BACKGROUND

Embodiments of the present disclosure relate to a system for content delivery system and more particularly to a system and a method for rendering contextual catalogue of products for electronic commerce platform.

Services providers are constantly developing new products and/or services as well as updating and improving their existing lines to keep up to date with market forces and to better meet the needs of consumers. More specifically, today's consumers frequently desire products, services, and/or solutions that work across different device types and/or media types such as websites, mobile applications, social networking services and the like. An increasingly popular and efficient way to offer such products and/or services to the consumers is to make them available online in an e-commerce portal. Generally, as particular needs of the consumers vary depending on their quantity or size, service providers often categorize their products and/or services online by consumer type and such products and/or services are usually advertised with descriptive information such as written and visual media, prices, offers or promotions and the like. Various content delivery systems are available which provides detailed information about multiple products or services and helps in improving shopping experience of the consumers.

Conventionally the content delivery systems which are available creates product catalogues in a form of a printed paper bound and distributed to consumers for sale. However, some current solutions lack scalable product catalogues that are easily modified by a business or an e-commerce platform to meet the particular needs of various consumers without dependency upon information technology (IT) specialists or IT releases. Also, dependency upon the IT specialists or the IT releases makes the overall process costly and inefficient. Moreover, such a conventional system limits browsing of the several products or services from multiple merchants or service providers and thus makes the merchants unable to provide their own product feed and update their electronic catalogues on a periodic basis.

Hence, there is a need for an improved system and a method for rendering contextual catalogue of products for electronic commerce platform in order to address the aforementioned issues.

### BRIEF DESCRIPTION

In accordance with an embodiment of the present disclosure, a system for rendering contextual catalogue of products for electronic commerce platform is disclosed. The system includes a processing subsystem hosted on a server. The processing subsystem is configured to execute on a network to control bidirectional communications among a plurality of modules. The processing subsystem includes a master catalogue generation module configured to receive one or more product details corresponding to the one or more products from a plurality of merchants via an application programming interface or web scrapping or file feeds. The master catalogue generation module is also configured to generate a master catalogue in a digital format for depicting information of the one or more products based on the one or more product details received. The processing subsystem also includes a contextual catalogue rendering module operatively coupled to the master catalogue generation module. The contextual catalogue rendering module is configured to identify a number of one or more web-based platforms associated with presentation of the master catalogue to target one or more audiences for depicting information of the one or more products. The contextual catalogue rendering module is also configured to determine a context of each of the one or more web-based platforms exhibiting the master catalogue for enabling purchasing of the one or more products by each category of the one or more audiences upon identification. The contextual catalogue rendering module is also configured to determine a category of each one or more web-based platforms selling one or more products to the one or more audiences targeted based on the context of each of the one or more web-based platforms. The contextual catalogue rendering module is also configured to match the category of each of the one or more web-based platforms determined with the corresponding plurality of merchants. The contextual catalogue rendering module is also configured to render one or more contextual catalogues corresponding to the master catalogue based on a matching result obtained upon determination of the context and scenario of each of the one or more web-based platforms, wherein the one or more contextual catalogues are exhibited in the one or more web-based platforms. The processing subsystem also include a catalogue modification module operatively coupled to the contextual catalogue rendering module. The catalogue modification module is configured to enable the plurality of merchants and one or more owners associated with the one or more web-based platforms to override the one or more contextual catalogues rendered based on a corresponding predefined requirement. The processing subsystem also includes a product purchasing facilitation module operatively coupled to the catalogue modification module. The product purchasing facilitation module is configured to facilitate purchasing of the one or more products selected from the one or more contextual catalogues via one or more purchasing options.

In accordance with another embodiment of the present disclosure, a method for rendering contextual catalogue of products for electronic commerce platform is disclosed. The method includes receiving, by a master catalogue generation module, one or more product details corresponding to the one or more products from a plurality of merchants via an application programming interface or web scrapping or file feeds. The method also includes generating, by the master catalogue generation module, a master catalogue in a digital format for depicting information of the one or more products based on the one or more product details received. The method also includes identifying, by a contextual catalogue rendering module, a number of one or more web-based platforms associated with presentation of the master catalogue to target one or more audiences for depicting information of the one or more products. The method also includes determining, by the contextual catalogue rendering module, a context of each of the one or more web-based platforms exhibiting the master catalogue for enabling purchasing of the one or more products by each category of the one or more audiences. The method also includes determining, by the contextual catalogue generation module, a category of each of the one or more web-based platforms selling the one or more products to the one or more audiences targeted based on the context of each of the one or more web-based platforms. The method also includes matching, by the contextual catalogue rendering module, the category of each of the one or more web-based platforms determined with the corresponding plurality of merchants. The method also includes rendering, by the contextual catalogue rendering module, one or more contextual catalogues corresponding to the master catalogue based on a matching result obtained upon determination of the context and scenario of each of the one or more web-based platforms, wherein the one or more contextual catalogues are exhibited in the one or more web-based platforms. The method also includes enabling, by a catalogue modification module, the plurality of merchants and one or more owners associated with the one or more web-based platforms to override the one or more contextual catalogues rendered based on a corresponding predefined requirement. The method also includes facilitating, by a product purchasing facilitation module, purchasing of the one or more products selected from the one or more contextual catalogues via one or more purchasing options.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram of a system for rendering contextual catalogue of products for electronic commerce platform in accordance with an embodiment of the present disclosure;

FIG. 2 is a block diagram representation of an embodiment of a system for rendering contextual catalogue of products for electronic commerce platform of FIG. 1 in accordance with an embodiment of the present disclosure;

FIG. 3 illustrates a schematic representation of an exemplary embodiment of a system for rendering contextual catalogue of products for electronic commerce platform of FIG. 1 in accordance with an embodiment of the present disclosure;

FIG. 4 is a block diagram of a computer or a server in accordance with an embodiment of the present disclosure; and

FIG. 5 (a) and FIG. 5 (b) is a flow chart representing the steps involved in a method for rendering contextual catalogue of products for electronic commerce platform of FIG. 1 in accordance with the embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and a method for rendering contextual catalogue of products for electronic commerce platform. The system includes a processing subsystem hosted on a server. The processing subsystem is configured to execute on a network to control bidirectional communications among a plurality of modules. The processing subsystem includes a master catalogue generation module configured to receive one or more product details corresponding to the one or more products from a plurality of merchants via an application programming interface or web scrapping or file feeds. The master catalogue generation module is also configured to generate a master catalogue in a digital format for depicting information of the one or more products based on the one or more product details received. The processing subsystem also includes a contextual catalogue rendering module operatively coupled to the master catalogue generation module. The contextual catalogue rendering module is configured to identify a number of one or more web-based platforms associated with presentation of the master catalogue to target one or more audiences for depicting information of the one or more products. The contextual catalogue rendering module is also configured to determine a context of each of the one or more web-based platforms exhibiting the master catalogue for enabling purchasing of the one or more products by each category of the one or more audiences upon identification. The contextual catalogue rendering module is also configured to determine a category of each the one or more web-based platforms selling the one or more products to the one or more audiences targeted based on the context of each of the one or more web-based platforms. The contextual catalogue rendering module is also configured to match the category of each of the one or more web-based platforms determined with the corresponding plurality of merchants. The contextual catalogue rendering module is also configured to render one or more contextual catalogues corresponding to the master catalogue based on a matching result obtained upon determination of the context and scenario of each of the one or more web-based platforms, wherein the one or more contextual catalogues are exhibited in the one or more web-based platforms. The processing subsystem also include a catalogue modification module operatively coupled to the contextual catalogue rendering module. The catalogue modification module is configured to enable the plurality of merchants and one or more owners associated with the one or more web-based platforms to override the one or more contextual catalogues rendered based on a corresponding predefined requirement. The processing subsystem also includes a product purchasing facilitation module operatively coupled to the catalogue modification module. The product purchasing facilitation module is configured to facilitate purchasing of the one or more products selected from the one or more contextual catalogues via one or more purchasing options.

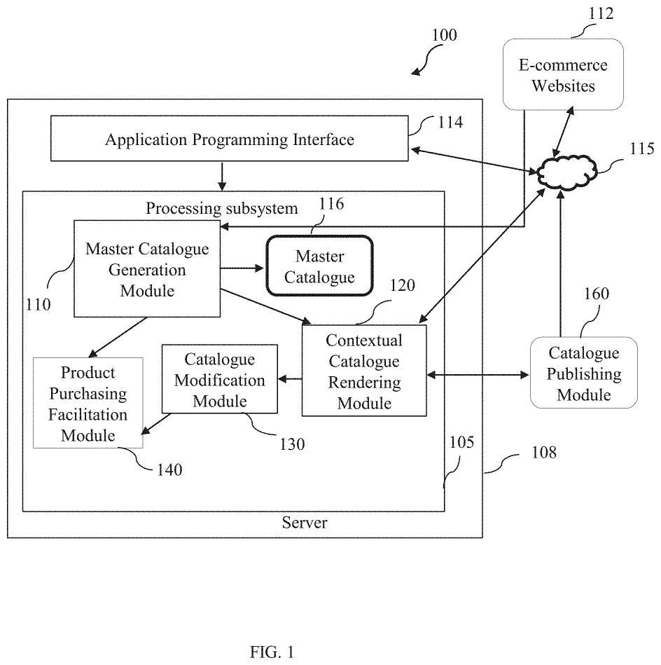

FIG. 1 is a block diagram of a system 100 for rendering contextual catalogue of products for electronic commerce platform in accordance with an embodiment of the present disclosure. The system 100 includes a processing subsystem 105 hosted on a server 108. In one embodiment, the server 108 may include a cloud server. In another embodiment, the server 108 may include a local server. The processing subsystem 105 is configured to execute on a network (not shown in FIG. 1) to control bidirectional communications among a plurality of modules. In one embodiment, the network may include a wired network such as local area network (LAN). In another embodiment, the network may include a wireless network such as Wi-Fi, Bluetooth, Zigbee, near field communication (NFC), infra-red communication (RFID) or the like.

The processing subsystem 105 includes a master catalogue generation module 110 configured to receive one or more product details corresponding to the one or more products from a plurality of merchants via an application programming interface (API) 114 or web scrapping or file feeds. In one embodiment, the one or more product details may include at least one of a color of the one or more products, a size of the one or more products, a price of the one or more products, an available quantity of the one or more products, a category of the one or more products, a selling price of the one or more products, a manufacturer suggested retail price (MSRP) of the one or more products or a combination thereof. As used herein, the term ‘application programming interface’ is defined as a computing interface which defines interactions between multiple software applications or mixed hardware-software intermediaries.

The master catalogue generation module 110 is also configured to generate a master catalogue 116 in a digital format for depicting information of the one or more products based on the one or more product details received. As used herein, the term ‘master catalogue’ is defined as a catalogue which enables sharing details of products and managing inventory across all catalogues that use products in it, regardless of the site, location, or channel used to sell products. In one embodiment, the one or more products may include, but not limited to, an electronic product, an apparel, a food product, a health product, a stationary product and the like. In a specific embodiment, the one or more product details fetched from the plurality of merchants are stored in product database hosted on the cloud server.

The processing subsystem 105 also includes a contextual catalogue rendering module 120 operatively coupled to the master catalogue generation module 110. The contextual catalogue rendering module 120 is configured to identify a number of one or more web-based platforms associated with presentation of the master catalogue to target one or more audiences for depicting information of the one or more products. As used herein, the term ‘one or more web-based platforms’ is defined as one or more platforms which enables to build solutions that enable delivery of content, services and even applications over the HTTP protocol. In one embodiment, the one or more web-based platforms may include one or more mobile applications. In another embodiment, the web-based platforms may include one or more electronic commerce websites 112.

In a specific embodiment, the contextual catalogue rendering module 120 is configured to identify a category of one or more audiences involved in viewing the master catalogue of the one or more products presented at the one or more web-based platforms via one or more audience identification process. In such embodiment, the one or more audiences may include at least one of one or more potential buyers, one or more window shoppers, one or more cart abundance audiences, one or more loyal audiences or a combination thereof. In one embodiment, the one or more audience identification process may include at least one of online surveys, historic purchasing pattern of one or more audiences, activities performed by one or more audiences on the one or more web-based platforms or a combination thereof. In such embodiment, the activities performed by the one or more audiences may include, but not limited to a visit at the one or more websites by the one or more audiences, a browsing history of the one or more audiences and the like.

The contextual catalogue rendering module 120 is also configured to determine a context of each of the one or more web-based platforms exhibiting the master catalogue for enabling purchasing of the one or more products by each category of the one or more audiences upon identification. The context of each of the one or more web-based platforms are determined based on content analysis, content filtration and content transformation process. The contextual catalogue rendering module 120 is also configured to determine a category of each the one or more web-based platforms selling the one or more products to the one or more audiences targeted based on the context of each of the one or more web-based platforms. In one embodiment, the category of each of the one or more web-based platforms may include, but not limited to, an apparel selling category, an electronic product selling category, a food product selling category, a fashion accessories selling category, a pet care product category, footwear selling category and the like.

The contextual catalogue rendering module 120 is also configured to match the category of each of the one or more web-based platforms determined with the corresponding plurality of merchants. The category of each of the one or more web-based platforms are matched with type of the one or more products available with the corresponding plurality of merchants. The contextual catalogue rendering module is also configured to render one or more contextual catalogues corresponding to the master catalogue based on a matching result obtained upon determination of the context and scenario of each of the one or more web-based platforms, wherein the one or more contextual catalogues are exhibited in the one or more web-based platforms. In one embodiment, the context may include, but not limited to, an age group of the audiences, a primary usage of the one or more web-based platforms by the one or more audiences, a preference of the one or more audiences, location of the one or more audiences, activities performed by one or more audiences and the like.

The processing subsystem 105 also includes a catalogue modification module 130 operatively coupled to the contextual catalogue rendering module 120. The catalogue modification module 130 is configured to enable the plurality of merchants and one or more owners associated with the one or more web-based platforms to override the one or more contextual catalogues rendered based on a corresponding predefined requirement. For example, the owners associated with the one or more web-based platforms may update the one or more product details at regular intervals. Similarly, the plurality of merchants may also change or update the one or more product details in real-time in order to make the process transparent for the one or more target audiences. The catalogue modification module 130 is configured to allow the merchant or a brand to override the default to list or not list their catalogue or part of the catalogue in certain one or more web-based platforms.

The processing subsystem 105 also includes a product purchasing facilitation module 140 operatively coupled to the catalogue modification module 130. The product purchasing facilitation module 140 is configured to facilitate purchasing of the one or more products selected from the one or more contextual catalogues via one or more purchasing options. In one embodiment, the one or more purchasing options may include a direct purchasing option from the one or more web-based platforms. Similarly, the one or more payment options may include a redirected purchasing option to a plurality of platforms associated with the plurality of merchants.

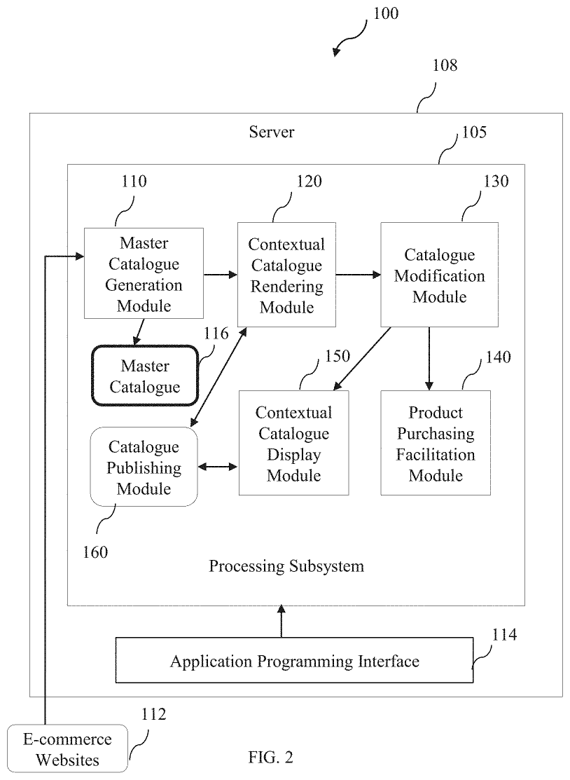

FIG. 2 is a block diagram representation of an embodiment of a system for rendering contextual catalogue of products for electronic commerce platform of FIG. 1 in accordance with an embodiment of the present disclosure. As described in aforementioned FIG. 1, the system 100 includes a processing subsystem 105 which is hosted on a server 108. The processing subsystem 105 includes a master catalogue generation module 110, a contextual catalogue rendering module 120, a catalogue modification module 130 and a product purchasing module 140. In addition, the processing subsystem 105 also includes a contextual catalogue display module 150 operatively coupled to the contextual catalogue rendering module 120. The contextual catalogue display module 150 is configured to provide a virtual environment for displaying the one or more contextual catalogues based on a state of each of the one or more products. The contextual catalogue display module 150 displays the one or more products in a virtual reality interface to attract the one or more audiences in viewing the one or more products from various angles. Based on the identification of the state of each of the one or more products, the one or more products are displayed on the virtual environment. The state of each of the one or more products may include but not limited to, identification of a necessity of a product for displaying in the virtual environment. In one embodiment, a type of each of the one or more products displayed on the virtual environment may include a cosmetic product, a fashion apparel, a fashion accessory, a home decor product, an eyewear and the like. The processing subsystem 105 also includes a catalogue publishing module 160 operatively coupled to the contextual catalogue rendering module 120 and the contextual catalogue display module 150. The catalogue publishing module 160 is configured to connect with the one or more owners associated with the one or more web-based platforms for determining publishing requirement of the one or more contextual catalogues in a virtual environment provided by the contextual catalogue display module 150.

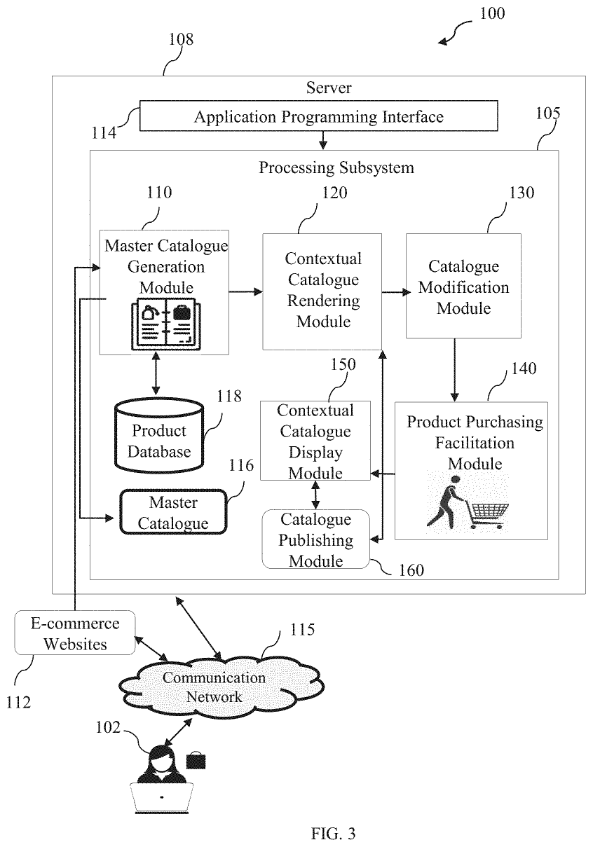

FIG. 3 illustrates a schematic representation of an exemplary embodiment of a system for rendering contextual catalogue of products for electronic commerce platform of FIG. 1 in accordance with an embodiment of the present disclosure. Considering an example, where the system 100 is utilized by an e-commerce platform ‘X’. In such a scenario, let's assume that an audience 102 ‘A’ is interested in shopping from the e-commerce platform ‘X’. To attract the audience ‘A’ 102, the system 100 offers a master catalogue for depicting lists and details of one or more products. In the example used herein, the master catalogue which is shown to the audience is generated by a master catalogue generation module 110 of a processing subsystem 105. Here, the processing subsystem 105 is hosted on a cloud server 108, wherein the processing subsystem 105 executes on a network 115 to control bidirectional communications among a plurality of modules.

Here, the master catalogue generation module 110 receives one or more product details corresponding to the one or more products from a plurality of merchants via an application programming interface (API) or web scrapping or file feeds. For example, the one or more product details may include at least one of a color of the one or more products, a size of the one or more products, a price of the one or more products, an available quantity of the one or more products, a category of the one or more products, a selling price of the one or more products, a manufacturer suggested retail price (MSRP) of the one or more products or a combination thereof. Again, based on the one or more product details received, the master catalogue generation module 110 generates a master catalogue in a digital format for depicting information of the one or more products. In the example used herein, the one or more products may include, but not limited to, an electronic product, an apparel, a food product, a health product, a stationary product and the like. Also, the one or more product details fetched from the plurality of merchants are stored in product database 118 hosted on the cloud server 108.

Once the master catalogue is generated, a contextual catalogue rendering module 120 of the processing subsystem 105 identifies a number of one or more web-based platforms associated with presentation of the master catalogue to target one or more audiences for depicting information of the one or more products. In the example used herein, the one or more web-based platforms may include one or more mobile applications. Also, the contextual catalogue rendering module 120 identifies a category of the audience involved in viewing the master catalogue of the one or more products presented at the one or more web-based platforms via one or more audience identification process. For example, the category of the audience may include, at least one of a potential buyer, a window shopper, a cart abundance audience, a loyal audience or a combination thereof. Here, the one or more audience identification process may include at least one of online surveys, historic purchasing pattern of one or more audiences, activities performed by one or more audiences on the one or more web-based platforms or a combination thereof. In such an example, the activities performed by the audience may include, but not limited to a visit at the one or more websites by the audience, a browsing history of the audience and the like.

The contextual catalogue rendering module 120 also determines a context of each of the one or more web-based platforms exhibiting the master catalogue for enabling purchasing of the one or more products by each category of the one or more audiences upon identification. The context of each of the one or more web-based platforms are determined based on content analysis, content filtration and content transformation process. Again, the contextual catalogue rendering module 120 determines a category of each the one or more web-based platforms selling the one or more products to the one or more audiences targeted based on the context of each of the one or more web-based platforms. For example, the category of each of the one or more web-based platforms may include, but not limited to, an apparel selling category, an electronic product selling category, a food product selling category, a fashion accessories selling category, a pet care product category, footwear selling category and the like.

Upon identification of the category of each of the one or more web-based platforms, such categories are matched with the corresponding plurality of merchants. The contextual catalogue rendering module is also configured to render one or more contextual catalogues corresponding to the master catalogue based on a matching result obtained upon determination of the context and scenario of each of the one or more web-based platforms, wherein the one or more contextual catalogues are exhibited in the one or more web-based platforms. For example, if web-based platform 1 is associated with the apparel selling, then the web-based platform 1 is linked with a corresponding apparel selling merchant. The contextual catalogue rendering module is provided a software development kit to enable the web-based platform 1 to show the relevant catalogue to sell to their audience by fetching the relevant catalogue from the apparel selling merchant.

Further, a catalogue modification module 130 enables the plurality of merchants and one or more owners associated with the one or more web-based platforms to override the one or more contextual catalogues rendered based on a corresponding predefined requirement. For example, the owners associated with the one or more web-based platforms may update the one or more product details on demand at regular intervals. Similarly, the plurality of merchants may also change or update the one or more product details in real-time in order to make the process transparent for the target audience. Also, the catalogue modification module 130 allows the merchant or a brand to override the default to list or not list their catalogue or part of the catalogue in certain one or more web-based platforms.

In addition, a product purchasing facilitation module 140 facilitates purchasing of the one or more products selected from the one or more contextual catalogues via one or more purchasing options. In the example used herein, the one or more purchasing options may include either a direct purchasing option from the one or more web-based platforms. In another scenario, the one or more payment options may include a redirected purchasing option to a plurality of platforms associated with the plurality of merchants. For example, here, the audience may be redirected to a website of a particular brand or directly to the corresponding merchant's website.

Furthermore, in order to provide better visualization options for the one or more products during purchasing activity, a contextual catalogue display module 150 provides a virtual environment for displaying the one or more contextual catalogues based on a state of each of the one or more products. Here, the contextual catalogue display module 150 displays the one or more products in a virtual reality interface to attract the one or more audiences in viewing the one or more products from various angles. Based on the identification of the state of each of the one or more products, the one or more products are displayed on the virtual environment. The state of each of the one or more products may include but not limited to, identification of a necessity of a product for displaying in the virtual environment. In the example used herein, a type of each of the one or more products displayed on the virtual environment may include a cosmetic product, a fashion apparel, a fashion accessory, a home decor product, an eyewear and the like. Thus, the system 100 helps in reducing the cost required to publish multiple unnecessary and irrelevant catalogues without determining the context and also allow merchants to update and revise their electronic catalogues on demand in order to provide with one stop shopping experience for multiple merchants as well as the audience.

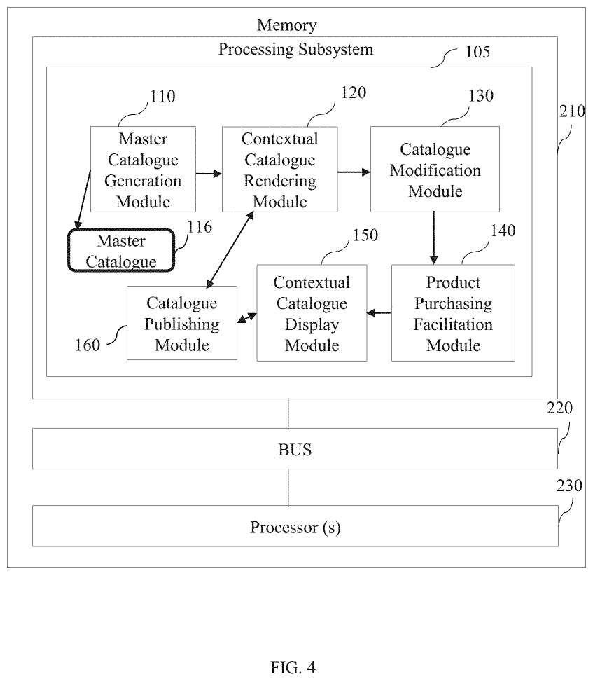

FIG. 4 is a block diagram of a computer or a server in accordance with an embodiment of the present disclosure. The server 200 includes processor(s) 230, and memory 210 operatively coupled to the bus 220. The processor(s) 230, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 210 includes several subsystems stored in the form of executable program which instructs the processor 230 to perform the method steps illustrated in FIG. 1. The memory 210 includes a processing subsystem 105 of FIG. 1. The processing subsystem 105 further has following modules: a master catalogue generation module 110, a contextual catalogue rendering module 120, a catalogue modification module 130, a product purchasing facilitation module 140 and a contextual catalogue display module 150.

The master catalogue generation module 110 is configured to receive one or more product details corresponding to the one or more products from a plurality of merchants via an application programming interface or web scrapping or file feeds. The master catalogue generation module 110 is also configured to generate a master catalogue in a digital format for depicting information of the one or more products based on the one or more product details received. The contextual catalogue rendering module 120 is configured to identify a number of one or more web-based platforms associated with presentation of the master catalogue to target one or more audiences for depicting information of the one or more products. The contextual catalogue rendering module 120 is also configured to determine a context of each of the one or more web-based platforms exhibiting the master catalogue for enabling purchasing of the one or more products by each category of the one or more audiences upon identification. The contextual catalogue rendering module 120 is also configured to determine a category of each the one or more web-based platforms selling the one or more products to the one or more audiences targeted based on the context of each of the one or more web-based platforms. The contextual catalogue rendering module 120 is also configured to match the category of each of the one or more web-based platforms determined with the corresponding plurality of merchants. The contextual catalogue rendering module 120 is also configured to render one or more contextual catalogues corresponding to the master catalogue based on a matching result obtained upon determination of the context and scenario of each of the one or more web-based platforms, wherein the one or more contextual catalogues are exhibited in the one or more web-based platforms. The catalogue modification module 130 is configured to enable the plurality of merchants and one or more owners associated with the one or more web-based platforms to override the one or more contextual catalogues rendered based on a corresponding predefined requirement. The product purchasing facilitation module 140 is configured to facilitate purchasing of the one or more products selected from the one or more contextual catalogues via one or more purchasing options. The contextual catalogue display module 150 is configured to provide a virtual environment for displaying the one or more contextual catalogues based on a state of each of the one or more products.

The bus 220 as used herein refers to be internal memory channels or computer network that is used to connect computer components and transfer data between them. The bus 220 includes a serial bus or a parallel bus, wherein the serial bus transmits data in bit-serial format and the parallel bus transmits data across multiple wires. The bus 220 as used herein, may include but not limited to, a system bus, an internal bus, an external bus, an expansion bus, a frontside bus, a backside bus and the like.

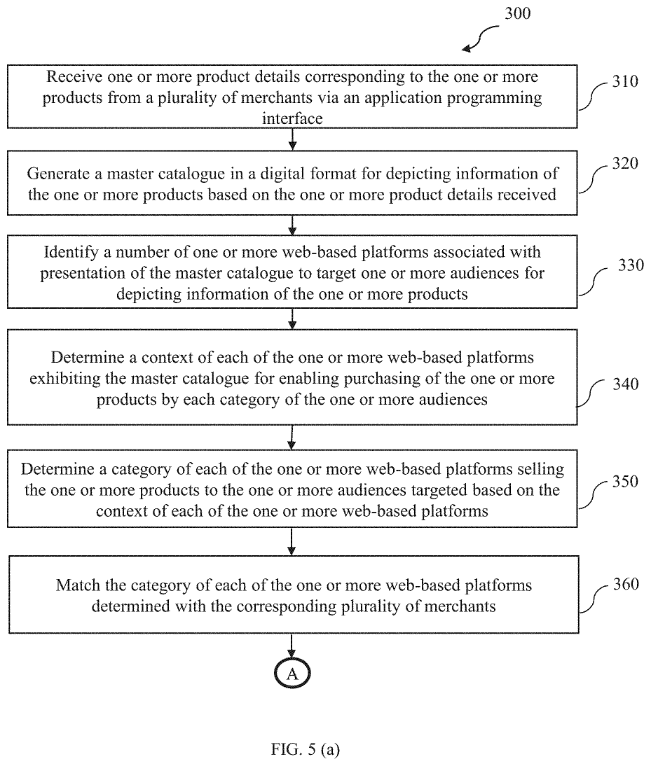

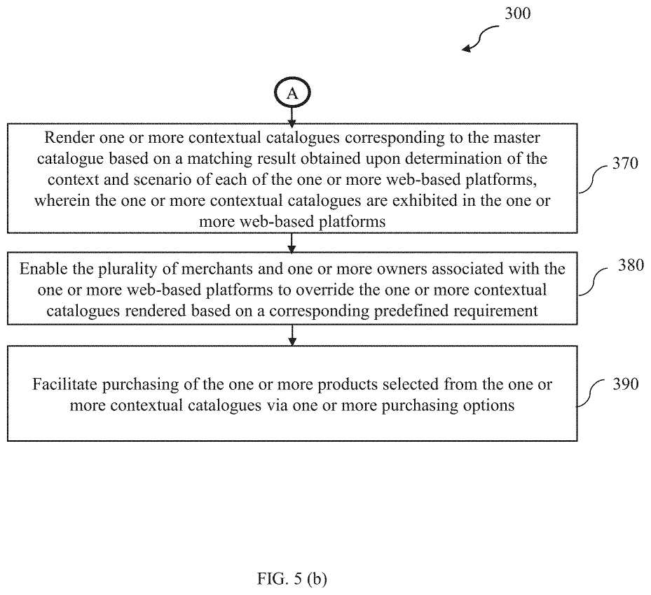

FIG. 5 (a) and FIG. 5(b) is a flow chart representing the steps involved in a method 300 for rendering contextual catalogue of products for electronic commerce platform of FIG. 1 in accordance with the embodiment of the present disclosure. The method 300 includes receiving, by a master catalogue generation module, one or more product details corresponding to the one or more products from a plurality of merchants via an application programming interface or web scrapping or file feeds in step 310. In one embodiment, receiving the one or more product details corresponding to the one or more products from the plurality of merchants may include receiving the one or more product details which may include at least one of a color of the one or more products, a size of the one or more products, a price of the one or more products, an available quantity of the one or more products, a category of the one or more products, a selling price of the one or more products, a manufacturer suggested retail price (MSRP) of the one or more products or a combination thereof.

The method 300 also includes generating, by the master catalogue generation module, a master catalogue in a digital format for depicting information of the one or more products based on the one or more product details received in step 320. In one embodiment, generating the master catalogue in the digital format for depicting the information of the one or more products may include generating the master catalogue for the one or more products including, but not limited to, an electronic product, an apparel, a food product, a health product, a stationary product and the like. In a specific embodiment, the one or more product details fetched from the plurality of merchants are stored in product database hosted on the cloud server.

The method 300 also includes identifying, by a contextual catalogue rendering module, a number of one or more web-based platforms associated with presentation of the master catalogue to target one or more audiences for depicting information of the one or more products in step 330. In some embodiment, identifying the number of the one or more web-based platforms associated with presentation of the master catalogue to target the one or more audiences may include identifying one or more mobile applications and one or more websites.

The method 300 also includes determining, by the contextual catalogue rendering module, a context of each of the one or more web-based platforms exhibiting the master catalogue for enabling purchasing of the one or more products by each category of the one or more audiences in step 340. In one embodiment, determining the context of each of the one or more web-based platforms exhibiting the master catalogue may include identifying the context of the one or more web-based platforms by identifying the one or more audiences including at least one of one or more potential buyers, one or more window shoppers, one or more cart abundance audiences, one or more loyal audiences or a combination thereof. In one embodiment, the one or more audience identification process may include at least one of online surveys, historic purchasing pattern of one or more audiences, activities performed by one or more audiences on the one or more web-based platforms or a combination thereof.

The method 300 also includes determining, by the contextual catalogue generation module, a category of each of the one or more web-based platforms selling the one or more products to the one or more audiences targeted based on the context of each of the one or more web-based platforms in step 350. In some embodiment, determining the category of each of the one or more web-based platforms selling the one or more products to the one or more audiences may include determining an apparel selling category, an electronic product selling category, a food product selling category, a fashion accessories selling category, a pet care product category, footwear selling category and the like.

The method 300 also includes matching, by the contextual catalogue rendering module, the category of each of the one or more web-based platforms determined with the corresponding plurality of merchants in step 360. The method 300 also includes rendering, by the contextual catalogue rendering module, one or more contextual catalogues corresponding to the master catalogue based on a matching result obtained upon determination of the context and scenario of each of the one or more web-based platforms, wherein the one or more contextual catalogues are exhibited in the one or more web-based platforms in step 370.

The method 300 also includes enabling, by a catalogue modification module, the plurality of merchants and one or more owners associated with the one or more web-based platforms to override the one or more contextual catalogues rendered based on a corresponding predefined requirement in step 380. In one embodiment, enabling the plurality of merchants and the one or more owners associated with the one or more web-based platforms to override the one or more contextual catalogues may include enabling the plurality of merchants and the owners to change or update status of each of the one or more product details in real-time.

The method 300 also includes facilitating, by a product purchasing facilitation module, purchasing of the one or more products selected from the one or more contextual catalogues via one or more purchasing options in step 390. In one embodiment, facilitating purchasing of the one or more products selected from the one or more contextual catalogues via the one or more purchasing options may include facilitating the purchasing of the one or more products via a direct purchasing option from the one or more web-based platforms. In another embodiment, facilitating purchasing of the one or more products selected from the one or more contextual catalogues via the one or more purchasing options may include facilitating the purchasing of the one or more products via a redirected purchasing option to a plurality of platforms associated with the plurality of merchants.

Various embodiments of the present disclosure generate contextual based catalogues for the one or more products or services which benefits businesses or the e-commerce platforms to meet the particular needs of various consumers without dependency upon information technology (IT) specialists or IT releases.

Moreover, the present disclosed system makes the process of selecting the one or more products by the consumers simpler as well as efficient by reducing unnecessary hassle of printing the catalogues in a form of paper. Also, the present disclosed system helps in saving time of each of the one or more consumers in selecting the one or more products from the catalogues because of exact representation of the products on the catalogues.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for rendering a contextual catalogue of one or more products for electronic commerce platform comprising:
a processing subsystem hosted on a server and configured to execute on a network to control bidirectional communications among a plurality of modules comprising:
a master catalogue generation module configured to:
receive one or more product details corresponding to the one or more products from a plurality of merchants via an application programming interface or web scrapping or file feeds; and
generate a master catalogue in a digital format for depicting information of the one or more products based on the one or more product details received;
a contextual catalogue rendering module operatively coupled to the master catalogue generation module, wherein the contextual catalogue rendering module is configured to:
identify a number of one or more web-based platforms associated with presentation of the master catalogue to target one or more audiences for depicting information of the one or more products;
determine a context of each of the one or more web-based platforms exhibiting the master catalogue for enabling purchasing of the one or more products by each category of the one or more audiences upon identification;
determine a category of each of the one or more web-based platforms selling the one or more products to the one or more audiences targeted based on the context of each of the one or more web-based platforms;
match the category of each of the one or more web-based platforms determined with the corresponding plurality of merchants; and
render one or more contextual catalogues corresponding to the master catalogue based on a matching result obtained upon determination of the context and scenario of each of the one or more web-based platforms, wherein the one or more contextual catalogues are exhibited in the one or more web-based platforms;
a catalogue modification module operatively coupled to the contextual catalogue rendering module, wherein the catalogue modification module is configured to enable the plurality of merchants and one or more owners associated with the one or more web-based platforms to override the one or more contextual catalogues rendered based on a corresponding predefined requirement; and
a product purchasing facilitation module operatively coupled to the catalogue modification module, wherein the product purchasing facilitation module is configured to facilitate purchasing of the one or more products selected from the one or more contextual catalogues via one or more purchasing options.

2. The system of claim 1, wherein the server comprises a cloud server.

3. The system of claim 1, wherein the one or more product details comprises at least one of a color of the one or more products, a size of the one or more products, a price of the one or more products, an available quantity of the one or more products, a category of the one or more products, a selling price of the one or more products, a manufacturer suggested retail price of the one or more products or a combination thereof.

4. The system of claim 1, wherein the one or more products comprises at least one of an electronic product, an apparel, a food product, a health product, a stationary product or a combination thereof.

5. The system of claim 1, wherein the one or more product details fetched from the plurality of merchants are stored in a product database hosted on the server.

6. The system of claim 1, wherein the one or more web-based platforms comprises a mobile application.

7. The system of claim 1, wherein the one or more web-based platforms comprises a website.

8. The system of claim 1, wherein the contextual catalogue rendering module is configured to identify a category of one or more audiences involved in viewing the master catalogue of the one or more products presented at the one or more web-based platforms via one or more audience identification process.

9. The system of claim 8, wherein the category of the one or more audiences comprises at least one of one or more potential buyers, one or more window shoppers, one or more cart abundance audiences, one or more loyal audiences or a combination thereof.

10. The system of claim 8, wherein the one or more audience identification process comprises at least one of online surveys, historic purchasing pattern of one or more audiences, activities performed by one or more audiences on the one or more web-based platforms or a combination thereof.

11. The system of claim 1, wherein the one or more purchasing options comprises a direct purchasing option from the one or more web-based platforms or a redirected purchasing option to a plurality of platforms associated with the plurality of merchants.

12. The system of claim 1, wherein the processing subsystem comprising a contextual catalogue display module operatively coupled to the contextual catalogue rendering module, wherein the contextual catalogue display module is configured to provide a virtual environment for displaying the one or more contextual catalogues based on a state of each of the one or more products.

13. The system of claim 1, wherein the processing subsystem comprising a catalogue publishing module operatively coupled to the contextual catalogue rendering module and the contextual catalogue display module, wherein the catalogue publishing module is configured to connect with the one or more owners associated with the one or more web-based platforms for determining publishing requirement of the one or more contextual catalogues in a virtual environment provided by the contextual catalogue display module.

14. A method comprising:
receiving, by a master catalogue generation module, one or more product details corresponding to the one or more products from a plurality of merchants via an application programming interface or web scrapping or file feeds;
generating, by the master catalogue generation module, a master catalogue in a digital format for depicting information of the one or more products based on the one or more product details received;
identifying, by a contextual catalogue rendering module, a number of one or more web-based platforms associated with presentation of the master catalogue to target one or more audiences for depicting information of the one or more products;
determining, by the contextual catalogue rendering module, a context of each of the one or more web-based platforms exhibiting the master catalogue for enabling purchasing of the one or more products by each category of the one or more audiences;
determining, by the contextual catalogue generation module, a category of each of the one or more web-based platforms selling the one or more products to the one or more audiences targeted based on the context of each of the one or more web-based platforms;
matching, by the contextual catalogue rendering module, the category of each of the one or more web-based platforms determined with the corresponding plurality of merchants;
rendering, by the contextual catalogue rendering module, one or more contextual catalogues corresponding to the master catalogue based on a matching result obtained upon determination of the context and scenario of each of the one or more web-based platforms, wherein the one or more contextual catalogues are exhibited in the one or more web-based platforms;
enabling, by a catalogue modification module, the plurality of merchants and one or more owners associated with the one or more web-based platforms to override the one or more contextual catalogues rendered based on a corresponding predefined requirement; and
facilitating, by a product purchasing facilitation module, purchasing of the one or more products selected from the one or more contextual catalogues via one or more purchasing options.

15. The method of claim 13, comprising providing, by a contextual catalogue display module, a virtual environment for displaying the one or more contextual catalogues based on a state of each of the one or more products.
